(19) United States
(12) Patent Application Publication
(10) Pub. No.: US 2015/0370057 A1
(43) Pub. Date: Dec. 24, 2015

(54) Method for operating a light microscope and optical assembly

(71) Applicant: Carl Zeiss Microscopy GmbH, Jena (DE)

(72) Inventor: Joerg Schaffer, Goettingen (DE)

(73) Assignee: Carl Zeiss Microscopy GmbH, Jena (DE)

(21) Appl. No.: 14/767,827

(22) PCT Filed: Feb. 5, 2014
(86) PCT No.: PCT/EP2014/052234

§ 371 Date: Aug. 13, 2015

(30) Foreign Application Priority Data
Feb. 15, 2013 (DE) 10 2013 002 640.7

(51) Int. Cl. G02B 21/14; G02B 21/18; G02B 21/00; G02B 21/36

(52) U.S. Cl. CPC G02B 21/14; G02B 21/361; G02B 21/365; G02B 21/18; G02B 21/0092

(57) ABSTRACT

The invention relates to a method for operating a light microscope, which comprises at least the following components: a modulator diaphragm for restricting a light cross-section, a sample plane, which is located in a beam path behind the modulator diaphragm and in which a sample can be positioned, a phase ring, which is arranged in the beam path behind the sample plane and along the cross-section of which incident light can be differently influenced, and a pupil camera for capturing a pupil image. The method involves the following steps: with the aid of a beam splitter, which is located in the beam path in front of the phase ring, light that emanates from the sample is guided in part to the pupil camera and in part to the phase ring; a pupil image, which is not influenced by the phase ring, is recorded and a sample image is simultaneously emitted; with the aid of electronic image processing means in the recorded pupil image, the position and size of an image of the modulator diaphragm, which is influenced by a sample but not influenced by the phase ring, is measured; a relative displacement between the phase ring and the modulator diaphragm is performed on the basis of the measured position and of the measured size of the image of the modulator diaphragm with the aid of electronic control means. The invention further relates to an corresponding optical arrangement.

The present invention relates in a first aspect to a method for operating a light microscope according to the preamble to claim 1.

From a second viewpoint, the invention relates to an optical assembly according to the preamble to claim 6.

In methods for operating a light microscope the light microscope has at least the following components: a modulator diaphragm for restricting a light cross-section, a specimen plane, which is located in an optical path behind the modulator diaphragm and in which a specimen can be positioned, a phase ring, which is arranged in the optical path behind the specimen plane, and a pupil camera for recording a pupil image. Incident light is differently influenced over the cross-section of the phase ring. In the method a relative displacement between the phase ring and the modulator diaphragm is performed, wherein the relative displacement is performed in dependence upon a detected position and a detected size of the image of the modulator diaphragm.

The light microscope can in principle be any light microscope, wherein a modulator diaphragm and a phase ring, which can be located in pupil planes, must be positioned in dependence upon each other. In particular it can be a phase contrast microscope. A phase ring can also be described as a phase contrast means and has at least two cross-sectional regions over its cross-section which differ in the degree of light permeability and/or in a generated phase shift. From light impinging on the phase ring, therefore, partial bundles that impinge on different cross-sectional regions are differently attenuated and/or phase-shifted. Through this phase shift an original phase offset between the partial bundles can be represented as an intensity difference in an interference image of the partial bundles. The shape of the phase ring can in principle be arbitrary, for example rectangular.

With the relative displacement, an appropriate orientation of the phase ring and the modulator diaphragm with respect to each other can be achieved. The modulator diaphragm comprises a light-permeable region which is to be imaged onto a specified region of the phase ring if there is no influencing by the specimen. The relative displacement is generally realised via an adjustable modulator diaphragm. This comprises a light-permeable region, annular in most cases, of which the size and position transversely to the optical path of the microscope can be adjusted.

An optical assembly is suited for arrangement in an optical path of a light microscope which has a modulator diaphragm for restricting a light cross-section, a specimen plane, which is arranged in the optical path behind the modulator diaphragm and in which a specimen can be positioned, and optical systems for generating an intermediate image of the specimen plane. The optical assembly comprises a phase ring, over the cross-section of which incident light can be differently influenced, and a pupil camera for recording a pupil image. A relative displacement between the modulator diaphragm and the phase ring can be performed in dependence upon a position and size, detected in the pupil image, of the image of the modulator diaphragm.

In an operating state in which the optical assembly is located in an optical path of a light microscope, the phase ring is arranged in the optical path behind the specimen plane.

If the light microscope is implemented as a phase contrast microscope any light microscope can be used, provided that it can be operated together with the optical assembly as a phase contrast microscope. Any light microscope which has a modulator diaphragm that is suited for a phase contrast illumination can thus be interpreted in the present disclosure as a phase contrast microscope.

The optical systems for generating an intermediate image of the specimen plane can be part of an objective or can also comprise the objective and possibly further optical means. The aforementioned imaging means generate an image of the intermediate image and thus of the specimen plane at the specimen image output terminal. A camera or an ocular can be connected thereto for direct observation.

The orientation of the modulator diaphragm and the phase ring relative to each other is a decisive factor in the quality of the recorded specimen image. For this purpose the phase contrast microscope described in JP 2010-008793A has a displaceable phase ring and a displaceable modulator diaphragm. An output of the specimen image is realised both via a camera and also via an ocular.

In addition a generic optical assembly for a phase contrast microscope is described in JP 2005-004088 A. Here, the modulator diaphragm is axially adjustable.

Undesirable influencing by the specimen shape can be problematic for a suitable positioning of the modulator diaphragm relative to the phase ring. This can arise for example with specimens in specimen pots, which are used in particular in microtiter plates or multiwell plates. If the specimen is dissolved in a liquid the liquid forms a water meniscus due to the surface tension. Through the curved surface, light is undesirably influenced in transmitted light measurements. The curved surface of the specimen liquid causes initially a change in scale of the image of the modulator diaphragm. This effect is dependent upon a momentarily observed specimen region. In addition a displacement of the specimen in order to examine a specimen region at the edge of the specimen container leads to a displacement of the image of the modulator diaphragm transversely to an optical axis of the light microscope.

Therefore, when changing the specimen and also when displacing the specimen, a renewed adjustment of the modulator diaphragm relative to the phase ring must be realised. For this, in known optical assemblies, a conversion is carried out, through which—instead of a specimen image—a pupil image is output. This can be realised for example by introducing a Bertrand lens into the optical path or by using a telescopic ocular. A pupil plane is to be understood to be a plane which is associated via the Fourier transformation with the specimen plane. The modulator diaphragm and the phase ring are generally each arranged in a pupil plane. The orientation thereof can thus be controlled in the pupil image. After a relative displacement between them, there is conventionally a change back to an output of the specimen image.

This process is on the one hand time-consuming. On the other hand there is a risk that, due to a defective orientation between the modulator diaphragm and the phase ring, specimen images for different specimen regions are not comparable with each other.

On the basis of this problem, it was proposed in U.S. Pat. No. 6,238,911 B1 to place correction covers on the specimen containers. The correction covers have a curved surface in order to compensate, via a lens effect, for the consequences of the curved surface of the specimen liquids. A disadvantage hereof is that existing specimen containers, for which no special correction covers are available, are still subject to the aforementioned disadvantages. In addition, access to the specimen liquid is restricted by the correction covers. The introduction of active ingredients or other substances into the specimen containers is thus hindered.

In order to limit negative consequences of the specimen surface, a pinhole is used, instead of an annular modulator diaphragm, in the aforementioned specification JP 2010-008793 A. Correspondingly the phase ring is in a rod form there. Essentially only one direction of the beam deflection through the specimen surface must be considered. Indeed the orientation of the modulator diaphragm and the phase ring relative to each other can thus be simplified. The resolution achieved is, however, not isotropic. In addition the manual displacement requirements continue to be high.

It can be regarded as an object of the invention to indicate a method for operating a light microscope and an optical assembly to be arranged in an optical path of a light microscope, with which specimen images of a particularly good quality can be produced, with effort for the user being particularly low.

This object is achieved through the method having the features of claim 1 and through the optical assembly having the features of claim 6.

Advantageous variants of the method according to the invention and preferred embodiments of the optical assembly according to the invention are the subject matter of the dependent claims and are additionally explained in the following description, in particular in connection with the figures.

A method according to the invention for operating a light microscope which has at least the following components: a modulator diaphragm for restricting a light cross-section, a specimen plane, which is located in an optical path behind the modulator diaphragm and in which a specimen can be positioned, a phase ring, which is arranged in the optical path behind the specimen plane and over the cross-section of which incident light is differently influenced, and a pupil camera for recording a pupil image, has the method steps that, with a beam splitter located in the optical path in front of the phase ring, light coming from the specimen is guided in part to the pupil camera and in part to the phase ring; a pupil image which is uninfluenced by the phase ring is recorded and simultaneously a specimen image is output; with electronic image processing means, the position and size of an image of the modulator diaphragm, which is influenced by a specimen and uninfluenced by the phase ring, are detected in the recorded pupil image; a relative displacement between the phase ring and the modulator diaphragm is performed with electronic control means in dependence upon the detected position and the detected size of the image of the modulator diaphragm.

An optical assembly according to the invention to be arranged in an optical path of a light microscope, which has a modulator diaphragm for restricting a light cross-section, a specimen plane located in the optical path behind the modulator diaphragm and in which a specimen can be positioned, and optical systems for generating an intermediate image of the specimen plane, has at least the following components: a phase ring, over the cross-section of which incident light can be differently influenced, imaging means, with which, when the optical assembly is arranged in the optical path of the light microscope, the intermediate image can be imaged via the phase ring at a specimen image output terminal, a pupil camera for recording a pupil image, and a beam splitter, which is arranged in the optical path in front of the phase ring, to guide light coming from the specimen in part to the pupil camera and in part to the phase ring, wherein the imaging means are designed, together with the beam splitter, to generate a pupil image which is uninfluenced by the phase ring, and to generate the pupil image simultaneously with the imaging of the intermediate image at the specimen image output terminal, wherein electronic image processing means are provided, with which the position and size of an image of the modulator diaphragm, which is influenced by a specimen and uninfluenced by the phase ring, can be detected in a recorded pupil image, and wherein electronic control means are provided, with which a relative displacement can be carried out between the modulator diaphragm and the phase ring in dependence upon the detected position and size of the image of the modulator diaphragm.

It can be regarded as a core idea of the invention to perform the relative displacement on the basis of an evaluation of a pupil image, in which an image of the modulator diaphragm is not influenced or superposed by the phase ring.

Conventionally, in the case of a manual relative displacement a pupil image is observed, in which the images of the modulator diaphragm and the phase ring are superposed. While a user observes this pupil image he carries out the relative displacement until the images of the modulator diaphragm and the phase ring are brought into congruence.

A quicker and more precise determination of a suitable relative displacement is facilitated by electronic image processing means. A position detection of the image of the modulator diaphragm can be carried out particularly precisely with image processing means if superposition with an image of the phase ring does not have to be considered. This is achieved according to the invention by the arrangement of a beam splitter before the phase ring. The image processing means can for example detect, through evaluations for the edge detection known in principle and/or on the basis of brightness distributions, a position and size of the image of the modulator diaphragm. More complex image processing methods that incorporate an image of the phase ring are not necessary. In addition speed advantages can be achieved in comparison with the case in which a phase ring greatly absorbs light over regions of its cross-section and sufficient light for an electronic image evaluation is possibly received only for the remaining regions, in which light is for the large part forwarded.

As the relative displacement is realised automatically via image processing means and electronic control means, the user does not necessarily have to be provided with a pupil image. Advantageously, therefore, an observation of the specimen by the user can be carried out simultaneously with a recording and evaluation of an image of the modulator diaphragm in a pupil plane. It is not therefore necessary for initially solely a pupil image to be output, with which a position of the image of the modulator diaphragm is detected, and only subsequently for a specimen image to be output.

A pupil camera is to be understood to be a camera which is arranged so that a pupil image is imaged on its light-sensitive surface. A camera can be formed by one or a plurality of spatially resolving light detectors.

The optical assembly and the method according to the invention can be suited for any light microscopes, wherein a modulator diaphragm in front of the specimen plane and a phase ring behind the specimen plane are to be displaced relative to each other. Apart from in the case of a phase contrast microscope, this is for example the case with Hoffmann modulation contrast microscopy. Here, the modulator diaphragm can have a, in particular rectangular, gap. Through the position of the gap, light is guided exclusively in an inclined manner onto the specimen plane. The phase ring comprises a plurality of regions with different light permeability. For example, a region with as full light permeability as possible, a partially light-permeable region and a region with essentially no light permeability can be provided. A phase gradient in the specimen determines the angle of a refraction of incident light. In dependence upon the phase gradient therefore light is guided onto one of the different regions of the phase ring. Phase gradients of the specimen can thus be conveyed/translated into brightness differences.

Depending upon the microscopy method the phase ring can cause a phase shift, a light absorption, a beam deflection and/or a polarisation change. The invention can thus also be used for microscopes which use differential interference contrast (DIC) or PIasDIC. In the latter case the phase ring is formed by two polarisers and a Wollaston prism arranged between them, wherein the polarisers are arranged crossed relative to each other in relation to the passage directions. The Wollaston prism splits light, in dependence upon polarisation, onto two spatially separated paths.

Irrespectively of the specific design of the microscope, the method according to the invention is preferably performed constantly during the microscope operation. The method is thereby automatically performed also after each displacement of the specimen. An effect on the image of the modulator diaphragm, changed by the specimen or the specimen liquid, can be immediately detected and considered. It can be provided that different relative displacements are automatically performed in dependence upon the specimen region under examination.

The relative displacement can be realised in principle both with an adjustable modulator diaphragm and also with an adjustable phase ring. The use of an adjustable modulator diaphragm has the advantage that these are already used in numerous light microscopes. In these, therefore, fewer components need to be added to carry out the method according to the invention.

Particular advantages are achieved, however, if the relative displacement is performed with a phase ring, over the cross-section of which a light intensity and a phase influencing of light can be variably set. Here, the phase ring is adjusted, preferably exclusively, in dependence upon an influencing of the position and the size of the image of the modulator diaphragm caused by the specimen. No displacement of the illumination via the modulator diaphragm is thus necessary. Due to the unchanged illumination, specimen images can be compared particularly well with each other for different specimen regions.

An adjustable phase ring can in addition lead to a greater detectable amount of light in comparison with an adjustable modulator diaphragm. In dependence upon the geometry of the specimen container used, inclined incident light is trimmed/blocked on walls of the specimen container. A displacement of the modulator diaphragm can lead to an even greater proportion of the incident light being trimmed by the walls. This is advantageously avoided by an adjustable phase ring.

A further advantage with an adjustable phase ring is also that a phase shift between background light and light deflected by the specimen can be variably adjusted. This is not possible with an adjustable modulator diaphragm.

In addition more compact structural forms of the optical assembly of the invention are facilitated via an adjustable phase ring. Electronic actuators are required for a phase ring or a modulator diaphragm which can be adjusted via the electronic control means. In the case of an adjustable phase ring these actuators can be arranged closely to the other components of the optical assembly. This is particularly important if the optical assembly is offered as a separate device, with which a conventional light microscope can be easily equipped.

A shape of the phase ring and the modulator diaphragm can be chosen to be the same. For example they can both be rectangular or annular. The relative displacement is realised preferably so that the phase ring and the image of the modulator diaphragm lie concentrically with respect to each other. If the phase ring and the modulator diaphragm have an annular shape, the mid-points of the annular shapes of the phase ring and of the image of the modulator diaphragm consequently coincide.

Furthermore a distortion of the image of the modulator diaphragm, caused by the specimen, can be compensated with the relative displacement. The image of an annular modulator diaphragm can deviate slightly from a ring shape. This can be compensated by the phase ring being adjusted to the detected shape of the image of the modulator diaphragm.

Finally, an influencing of the size of the image of the modulator diaphragm caused by the specimen can also be detected and compensated. A relative displacement can thus be carried out, wherein the size of a region of the phase ring, in which a specified phase influencing and/or light attenuation is realised, is adjusted increasingly with greater magnification of the image of the modulator diaphragm by the specimen. In particular the aforementioned region of the phase ring can be brought into congruence with the image of the modulator diaphragm.

The aforementioned adjustments can be achieved in principle by solely the pupil image being evaluated. For even more precise results, however, the specimen image can also be used. For this, it can be provided that the specimen image is recorded with a specimen camera, that the recorded specimen image is evaluated with electronic image processing means with respect to an evaluation variable and that the relative displacement between the phase ring and the modulator diaphragm is additionally performed in dependence upon the evaluation.

In dependence upon the evaluation variable used, a brightness distribution in the specimen image is evaluated in a different way. For example a contrast in the specimen image can be determined as an evaluation variable. Through the relative displacement the contrast is then to be maximised. The relative displacement can be based on an adjustment that has previously been detected via the pupil image and carried out. To maximise the contrast, the relative displacement can then be performed iteratively. For this, for example, an arbitrarily selected change in the adjustment of the phase ring or the modulator diaphragm can be realised, whereupon the contrast change is determined. The adjustment changes can usefully be limited to one or more types of changes, for example a change in size and/or a displacement of a region of the phase ring.

Similarly, a relative displacement can also be realised with a different evaluation variable. For example, an edge brightening in the specimen image can be determined as an evaluation variable. They are also described as halos and should be as limited as possible. An edge brightening is to be understood in that a bright region or a bright contour of the edge arises at an edge which separates two image regions of different brightness from each other. These bright regions do not correspond to a specimen structure. Instead they are based on the fact that different specimen regions generate different phase shifts while a specified phase shift is set at the phase ring. Ideally, therefore, the phase shift which is provided with the phase ring should be changed in dependence upon the respective specimen or the respective specimen region. In order to minimise the edge brightening in the specimen image, the electronic control means can be designed to vary the size of a phase shift that is produced with the phase ring. For phase shifts of different sizes, the edge brightening in each case in the specimen image is detected. The phase ring adjustment that leads to the least edge brightening is then selected and maintained as the phase ring adjustment or setting.

The shape and size of the region of greater light attenuation of the adjustable phase ring can accordingly be adjusted solely in dependence upon the pupil image or also additionally in dependence upon the specimen image. The size of the phase shift in this region is on the other hand detected solely from the specimen image.

The beam splitter can in principle be of any type and can comprise for example a partially light-permeable mirror. The latter can also be designed so that it either reflects or transmits light in dependence upon polarisation. A greater proportion of light is preferably guided with the beam splitter to the specimen image output terminal than to the pupil camera. The signal to noise ratio in the specimen image is then only negligibly influenced by the simultaneous generation of the pupil image. More than 70% of the incident light is preferably forwarded with the beam splitter to the specimen image output terminal. This proportion can be comparatively large, as the beam splitter is arranged in the optical path in front of the phase ring. As a considerable light attenuation is intended through the phase ring, sufficient light can be branched off to the pupil camera more easily when the beam splitter is arranged in front of the phase ring than if it is arranged behind it. This allows the pupil camera to record a pupil image of sufficiently good quality.

The phase ring preferably has at least one phase-shifting matrix with liquid crystal regions which can be switched between states, in which they differently influence a phase of passing light. Such phase rings can also be described as liquid crystal phase modulators (LCPM). Through different orientations of the liquid crystals, two or also more different phase influences of the passing light can be adjusted. Using a LCPM, a specific phase shift can be set easily and quickly for a cross-sectional region of any shape. Outside of this region a different phase shift is produced.

Alternatively, a reflecting phase ring is possible which is formed with a mirror with piezo elements arranged in a matrix form on its rear side. Via the piezo elements, curvatures of the mirror surface can be adjusted. The light routes for incident light and thus the phase shifts therefore differ over the cross-sectional area of the mirror.

In principle the phase ring can additionally have a plurality of mechanically movable diaphragm blades. A light attenuation can also hereby be achieved.

If a matrix with liquid crystal regions is used, the phase ring can also additionally have polarisation-influencing means in front of the matrix comprising liquid crystal regions. With the polarisation-influencing means, a polarisation direction of light can be set to adjust a light absorption through the liquid crystal regions. The polarisation-influencing means can in particular be a λ/2 plate.

The phase ring preferably has, for adjustment of a light absorption, a further matrix with matrix elements that can be adjusted independently of each other. The number of matrix elements of the further matrix and the phase-shifting matrix preferably coincide. The further matrix is preferably also formed with switchable liquid crystal regions. For an image quality that is as good as possible, preferably equal forms are set with both matrices. For the same light portion, both a light attenuation and also a specified phase shift can be achieved.

According to a preferred variant of the optical assembly according to the invention the phase ring is a transmitting phase ring, with which light can pass through to generate the specimen image. Through the transmitting configuration, the optical assembly can be relatively simply integrated into a microscope frame. The imaging means of the optical assembly can also be formed at least in part by lenses and/or mirrors which are provided in any case in a microscope frame.

According to a preferred alternative, the phase ring is a reflecting phase ring, with which light can be reflected to generate the specimen image. If the phase ring is designed as a LCPM, a better image quality can be achieved therewith. In addition in the case of a reflecting configuration, light can pass twice through the liquid crystals of the LCPM, whereby the maximum possible phase shift is twice as large as with a comparable transmitting configuration.

In the case of a reflecting phase ring, a further beam splitter can be provided in the optical path in front of the phase ring. This guides light coming from an objective and thus from the specimen to the phase ring and guides light coming from the phase ring to the specimen image output terminal. This beam splitter can transmit or reflect light in particular in dependence upon polarisation. It can thereby be ensured that light coming from the objective is substantially completely guided to the phase ring and light from the phase ring substantially completely to the specimen image output terminal.

It is particular simple to adapt or re-fit conventional light microscopes if the optical assembly has connection means for connection to a camera connection of the light microscope, in particular a phase contrast microscope. An intermediate image of the specimen plane can be provided at the camera connection of the light microscope, this intermediate image being further imaged by the optical assembly. Advantageously, in this embodiment of the invention, changes in the optical path within a microscope frame of the light microscope are not absolutely necessary. Instead it suffices to connect the optical assembly to a camera connection of a conventional light microscope. The objective of the light microscope can be provided without a phase ring for phase shifting and light attenuation.

A great flexibility of use and a simply subsequent addition facility are achieved if the optical assembly is formed as an intermediate tube. This has first connection means to connect to a tube connection of a light microscope and second connection means to connect a camera and/or an ocular. As previously described, a conventional light microscope can also be easily adapted here. No conversions on optical components held on the microscope frame are necessary. Additional devices to connect to the tube connection of a conventional light microscope can advantageously continue to be used in the present embodiment in that they are connected to the second connection means of the optical assembly.

The invention also relates to a light microscope with an optical assembly according to the invention. As previously described, this optical assembly can be designed as a device that can be subsequently added. Alternatively, the phase ring of the optical assembly can, however, also be housed inside a microscope frame of the light microscope. A microscope frame can be understood within the meaning of the invention to be a microscope base which comprises at least holding means for an objective and for a specimen holder or a specimen table. In particular a microscope frame can comprise optical components to generate an intermediate image of the specimen plane. If the phase ring is received within the microscope frame the imaging means of the optical assembly can be at least partially formed by optical components which are in any case provided on microscope frames. The total number of optical components can be kept lower, whereby advantages in the imaging quality and particularly space-saving embodiments can be realised.

The optical assembly according to the invention is preferably designed for automatic realisation of the method according to the invention and the variants thereof. Additional preferred method variants follow through the operation of the embodiments of the optical assembly according to the invention.

Further features and advantages of the invention will be described with reference to the attached schematic figures, in which:

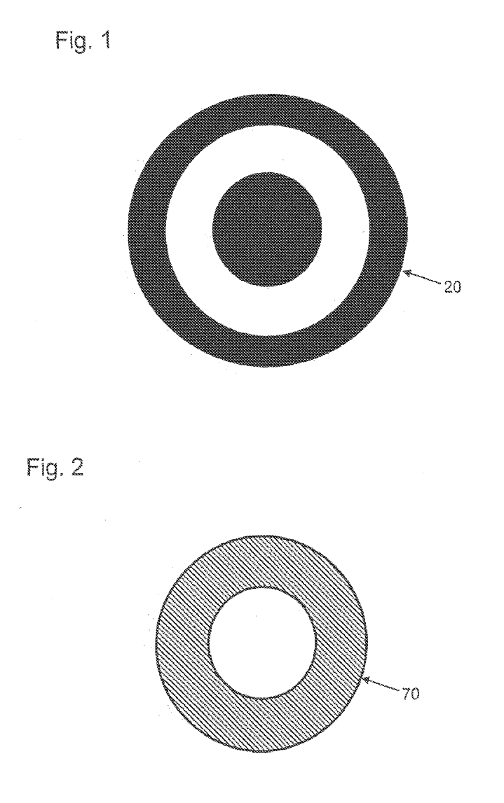

FIG. 1 shows an annular modulator diaphragm;

FIG. 2 shows an annular phase ring;

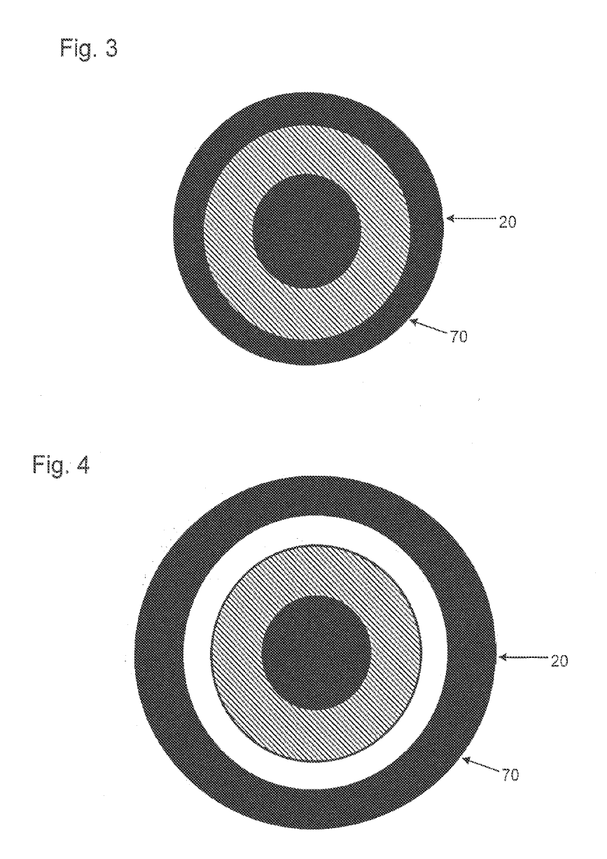

FIG. 3 shows a phase ring and the image of a modulator diaphragm;

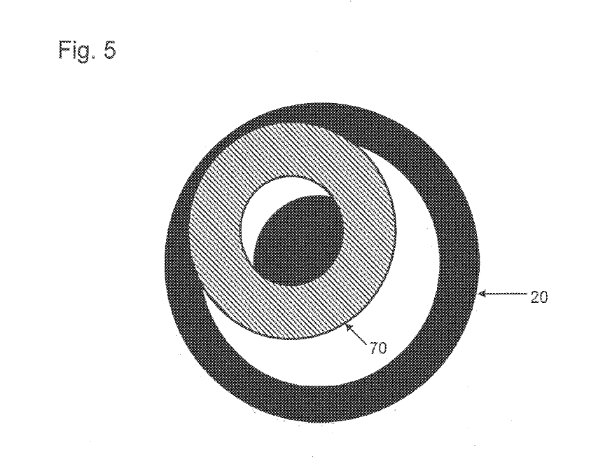

FIG. 4 shows a phase ring and an image of a modulator diaphragm, wherein an annular region of the image of the modulator diaphragm is larger than an annular region of the phase ring;

FIG. 5 shows a phase ring and an image of a modulator diaphragm which is offset relative to the phase ring;

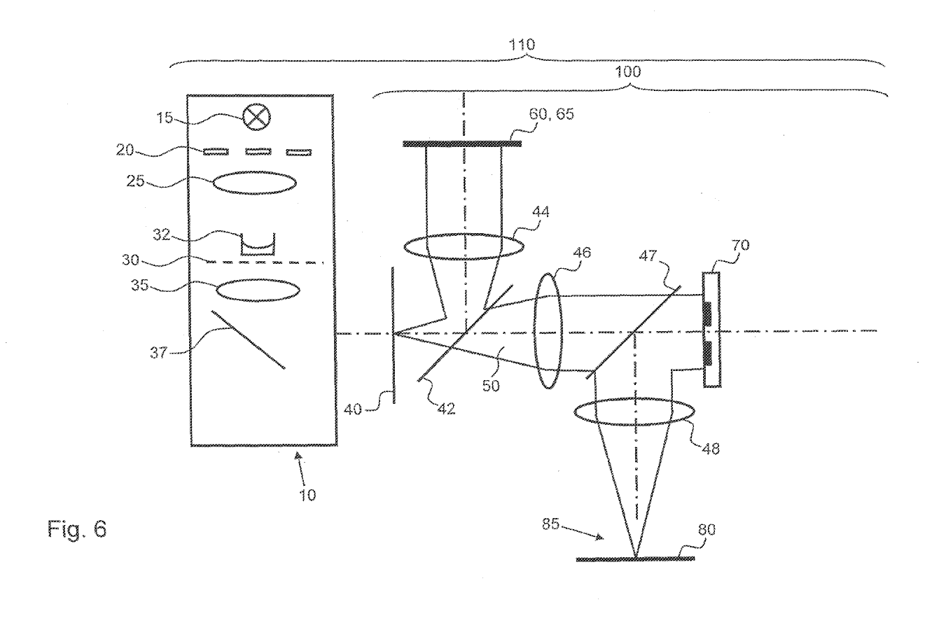

FIG. 6 shows a schematic illustration of a first embodiment of a light microscope according to the invention with an optical assembly according to the invention and

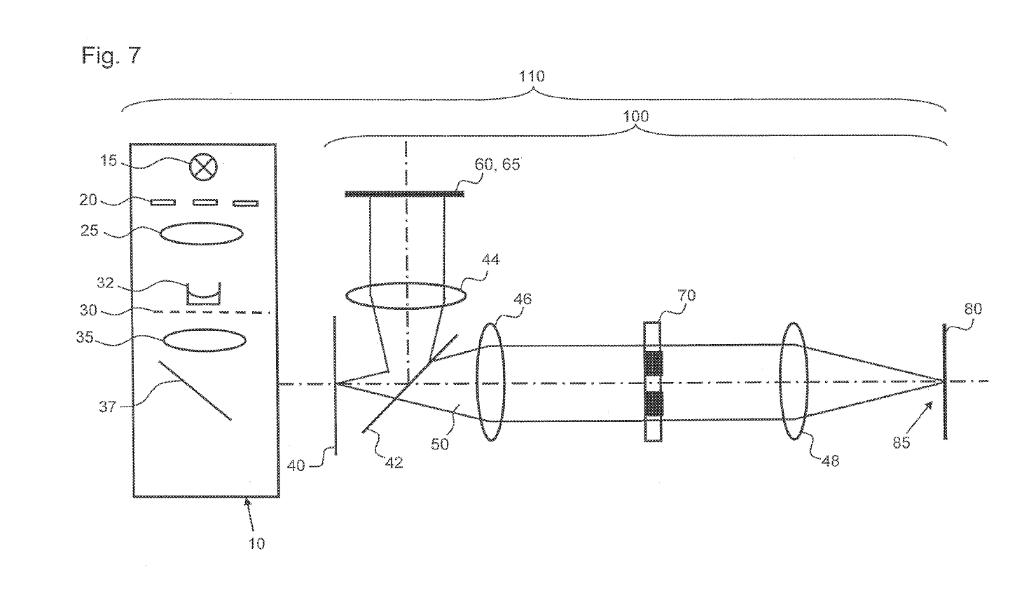

FIG. 7 shows a schematic illustration of a further embodiment of a light microscope according to the invention with an optical assembly according to the invention.

The same components and those acting in the same way are as a rule identified in the figures by the same reference numerals.

FIG. 1 shows schematically a modulator diaphragm 20 of a light microscope according to the invention. The modulator diaphragm 20 has a light-permeable region and a light-blocking region. In the example shown, the light-permeable region is ring-shaped. The modulator diaphragm is positioned in a pupil plane of a condenser of the light microscope. It is ensured through the position of the light-permeable region and the light-blocking region that essentially no light is guided perpendicularly, i.e. along an optical axis, into the specimen plane of the light microscope. Instead, the light passes solely in an inclined manner onto the specimen plane. Such a configuration is important for the image quality of a light microscope operated as a phase contrast microscope.

A modulator diaphragm is also used in other microscopy methods. For example in the case of Hoffmann phase contrast a modulator diaphragm with a generally slit-formed opening is used. The method, the optical assembly and the light microscope of the invention can thus also be used for other microscopy methods than the (Zernike) phase contrast method. Embodiments for the phase contrast method will be explained in detail below. For other microscopy methods, a different design, in particular shaping, of the modulator diaphragm and the phase ring can be provided.

With the annular modulator diaphragm 20, light impinges in an inclined manner onto a specimen in the specimen plane. A portion of the inclined incident light is deflected, in particular diffracted or refracted. A large proportion of the light continues to travel, however, without deflection in the specimen essentially in a straight line. This light portion is also described as background light. The light deflected by the specimen may have experienced a phase shift relative to the background light. This phase shift is made visible with a phase contrast microscope by the phase shift being conveyed into a light intensity difference. This is achieved by interference of the background light with the light deflected by the specimen. For this, an additional phase shift between the background light and the deflected light is necessary, this phase shift being generated via a phase ring. In addition a light attenuation of the background light is realised via the phase ring.

Such a phase ring 70 is shown schematically in FIG. 2. The phase ring 70 has in the example shown an annular shape and is also arranged in a pupil plane of the light microscope, i.e. in a plane conjugate to the plane of the modulator diaphragm 20. For the positioning of the phase ring 70 it is important that the light-permeable region of the modulator diaphragm 20 is imaged onto the region shown hatched-in in FIG. 2. In this region, incident light is attenuated and displaced in phase relative to light which impinges on the phase ring outside of the hatched-in region.

FIG. 3 shows schematically the case in which the phase ring 70 is brought into congruence with an image of the modulator diaphragm 20, i.e. an image into the plane of the phase ring 70. The congruence is to be achieved in the microscope operation where the image of the modulator diaphragm 20 can be influenced by a specimen arranged in the specimen plane.

This is significant in particular with specimens that are present in a liquid in a specimen pot. Such specimen pots are used for example in microtiter or multiwell plates. The specimen liquid generally forms a curved surface with respect to the walls of the specimen container. This curved surface can act like a lens.

If a central region within the specimen container is examined, the curved surface of the specimen liquid can cause a magnification or reduction in size of an image. Such a case is shown schematically in FIG. 4. Here, an image of the modulator diaphragm 20 is imaged magnified with respect to the example of FIG. 3. Ideally, therefore, in this case the dimensions of the phase ring 70 should be enlarged or the dimensions of the light-permeable region of the modulator diaphragm should be reduced.

Further difficulties are caused by a curved surface of the specimen liquid if a region outside of the centre of the specimen container is examined. In this case the curved surface of the specimen liquid can cause an inclination of the light passing through. This results in a displacement of the image of the modulator diaphragm 20 within the plane of the phase ring 70, as shown in FIG. 5. If no relative displacement is realised between the modulator diaphragm 20 and the phase ring 70, the image quality is significantly worsened. For a good image quality it is therefore necessary for a displacement of the modulator diaphragm and the phase ring relative to each other to be re-performed for each specimen. In addition this displacement should be adapted in the event of a change in a momentarily examined specimen region.

Through the light microscope according to the invention and the optical assembly according to the invention these displacement changes can be carried out automatically while a specimen image continues to be output to a user. It is not therefore necessary to interrupt the output of the specimen image in order to detect an effect of the surface of the specimen liquid upon the position and the dimensions of the image of the modulator diaphragm. Measurement interruptions can thereby be avoided and the user comfort increased. In addition, a particularly precise adaptation of the phase ring and the modulator diaphragm relative to each other can be realised in a short time.

A first example embodiment of a light microscope according to the invention, with which these advantages are achieved, is shown schematically in FIG. 6. The light microscope 110 comprises a microscope frame 10 and an optical assembly 100 according to the invention.

A light source 15 which can be part of the microscope frame 10 or be connectable to it emits light 50 towards a specimen plane 30. Initially the light travels through a modulator diaphragm 20. This is located in a pupil plane, i.e. a plane which is determined relative to the specimen plane 30 through a Fourier transformation. The light is then focused on the specimen plane 30 with a condenser 25. A specimen 32 can be positioned in this specimen plane 30. A curved surface of the specimen liquid is shown here. Light from the specimen is forwarded with optics 35, which can comprise in particular an objective, whereby an image of the specimen 32 can be produced in an intermediate image plane 40. In the example shown, the microscope frame 10 additionally comprises deflection means 37, for example a mirror, through which the intermediate image plane is produced in the region of a connection of the microscope frame 10. This connection can be a camera connection and/or a connection for a tube or intermediate tube.

The optical assembly 100 according to the invention comprises mechanical connection means (not shown), with which it is fixed to the connection of the microscope frame 10. The optical assembly 100 can advantageously also be used with conventional microscope frames.

Essential components of the optical assembly 100 are: a pupil camera 65, a specimen image output terminal 85 and an adjustable phase ring 70.

The pupil camera 65 is located in a pupil plane 60. It can record an image of the modulator diaphragm 20. Simultaneously with this recording, an image of the specimen 32 is generated in the region of the specimen image output terminal 85 in an image plane 80.

For this, initially a beam splitter 42 is arranged behind the intermediate image plane 40, the beam splitter 42 reflecting a portion of the incident light 50 and transmitting the remaining portion. With one of these portions of light, a pupil image is produced in the pupil plane 60 via an optical system 44. The remaining portion of the light 50 is guided with an optical system 46 towards the phase ring 70 and the image plane 80.

A further beam splitter 47 is arranged between the optical system 46 and the phase ring 70, which transmits or reflects incident light 50. Light 50 coming from the optical system 46 is guided substantially completely by the beam splitter 47 to the phase ring 70, in the example shown thus substantially completely transmitted. The phase ring 70 is thus a reflecting phase ring 70 here, whereby it throws back a proportion of the incident light 50. This thrown-back portion is guided by the beam splitter 47 substantially completely towards the image plane 80, thus reflected in the present case. This beam splitting can be realised for example in dependence upon polarisation. For a suitable polarisation direction of the light, further polarisation-changing means (not shown) can be arranged in the optical path. Alternatively, the beam splitter 47 can also be a partially permeable mirror, for example a 50:50 splitter, but with which great light losses are associated.

To produce a specimen image in the image plane 80, a further optical system 48 is provided in front of the image plane 80 and behind the beam splitter 47.

The optical systems 44, 46 and 48 can each be formed by a single lens or also a group of lenses consisting of a plurality of linked or spaced apart lenses. In addition to, or in place of, lenses, curved mirrors can also be used.

The total number of optical systems 44, 46 and 48 required can be kept low along with a comparatively simple optical design if the distances of the optical systems from each other or from a pupil plane or image plane are respectively 1f or 2f. f describes the focal length of the respective optical system 44, 46 and 48 and can be different for the different optical systems 44, 46 and 48.

A specimen camera and/or an ocular can be connected to the specimen image output terminal 85. The specimen image output terminal 85 is preferably formed for a mechanically releasable connection to a camera or an ocular, for example via a screw or plug-in connection.

The adjustment of the phase ring 70 is to be realised in dependence upon the influencing of the image of the modulator diaphragm 20 by the specimen 32, i.e. by the surface of the specimen liquid. For this, initially the pupil image which is recorded with the pupil camera 65 is evaluated with electronic image processing means (not shown). These detect a position of the modulator diaphragm image in the pupil image. In particular a size change caused by the specimen 32 and a displacement of the modulator diaphragm image are detected.

These data are used by electronic control means (not shown) to adjust the phase ring 70. In principle it can also be provided that the electronic control means can displace the modulator diaphragm 20 instead of the phase ring 70. In order to avoid having to carry out equipment changes to conventional microscope frames, however, the phase ring 70 is preferably adjusted. Via the cross-sectional area of the phase ring 70, the size, shape and position of a region can be adjusted, in which a light attenuation and a phase shift are different from those in a remaining region of the phase ring 70.

If for example it is detected with the image processing means that through the specimen 32 the modulator diaphragm 20 is shown magnified, said region of the phase ring 70 is also enlarged with respect to the starting adjustment. If it is detected that the specimen 32 causes a displacement of the image of the modulator diaphragm 20, said region of the phase ring 70 is displaced in the same direction. In particular it can be provided that the aforementioned light-attenuation and phase-shifting region of the phase ring 70 is brought into congruence with an image of the modulator diaphragm 20 which is influenced by the specimen 32.

In order that a phase shift can be variably adjusted via the cross-sectional area of the phase ring 70, the latter preferably comprises a phase-shifting matrix with liquid crystal regions. In dependence upon an adjustable orientation of the liquid crystals in the different regions, the phase can be differently shifted by light passing through.

In addition a light-attenuation effect is to be achieved. For this, the phase ring preferably comprises additional polarisation-influencing means, with which a polarisation direction is variably adjustable over the cross-section of incident light. The polarisation-influencing means can have in particular a further matrix with switchable liquid crystal regions. This further matrix can also be arranged in the illustrated optical path in front of the beam splitter 47 in the region of a pupil plane.

While the electronic control means adjust the phase ring 70 the output of a specimen image is already realised. The optical assembly 100 thus already outputs a specimen image while the pupil image is being evaluated and the phase ring 70 is automatically adjusted.

The electronic control means can also be designed to adjust the phase ring 70 additionally in dependence upon the generated specimen image. For this, the optical assembly 100 initially comprises a specimen camera which is connected to the specimen image output terminal 85. A specimen image recorded herewith is automatically evaluated with the electronic image processing means with respect to an evaluation variable. In dependence upon an evaluation result the phase ring 70 is displaced. This process can take place iteratively. The image processing means determine whether the displacement on the phase ring 70 has led to an improvement with respect to the evaluation variable. The next displacement of the phase ring 70 takes place in dependence thereon.

The evaluation variable can be an image contrast. With a first displacement of the phase ring 70, the light-attenuation and phase-shifting region can be enlarged. If this leads to a reduction in the image contrast, said region is reduced in size in a subsequent displacement of the phase ring 70 and the image contrast is evaluated once again. In this way an adjustment with the highest possible image contrast can be iteratively determined.

Additionally or alternatively, an undesired edge brightening in the specimen image can also be detected. In order to minimise this, in particular the size of a phase shift of the light-attenuation and phase-shifting region of the phase ring 70 can be varied.

Through the reflecting design of the phase ring 70, light 50 travels twice through its liquid crystal regions, whereby a maximum possible phase shift is twice as large as in the case of a transmitting design of the phase ring 70.

If the phase ring 70 uses a phase-shifting matrix of liquid crystal regions, in the case of a reflecting design the image quality is additionally generally better than in the case of a transmitting design.

However, a phase ring 70 with a transmitting design also offers advantages. A light microscope 110 according to the invention and an optical assembly 100 according to the invention with such a phase ring 70 are shown schematically in FIG. 7. As a result of the transmitting design the beam splitter 47 can be omitted. In addition an in principle more compact structural form is possible. Furthermore a transmitting design is particularly suited if the optical assembly 100 is to be accommodated within the microscope frame 10. In this case, the optical systems 46 and 48 can also be formed by optical systems which are already provided in conventional microscope frames.

For the evaluation of the pupil image which is recorded with the pupil camera 65 it is advantageous that the beam splitter 42 is arranged in the optical path in front of the phase ring 70. There is consequently no superposition in the pupil image with an image of the phase ring 70.

Through the optical assembly according to the invention and the method according to the invention, the effects of a specimen on the image of a modulator diaphragm can be taken into consideration particularly precisely and with time efficiency. For the best possible user comfort this can be realised automatically. In particular, specimens which are dissolved in a liquid with a curved surface can be examined particularly simply and accurately.

### LIST OF REFERENCE NUMERALS

10 Microscope frame
15 Light source
20 Modulator diaphragm
25 Condenser
30 Specimen plane
32 Specimen
35 Optics, objective
37 Mirror, deflection means
40 Intermediate image plane
42, 47 Beam splitter
44, 46, 48 Optical systems
50 Light
60 Pupil plane
65 Pupil camera
70 Phase ring
80 Specimen image plane
85 Specimen image output terminal
100 Optical assembly
110 Light microscope

1. A method for operating a light microscope,
wherein the light microscope has at least the following components:
a modulator diaphragm for restricting a light cross-section,
a specimen plane which is located in an optical path behind the modulator diaphragm and in which a specimen can be positioned,
a phase ring which is arranged in the optical path behind the specimen plane and over the cross-section of which incident light is differently influenced, and
a pupil camera for recording a pupil image,
wherein with a beam splitter which is located in the optical path in front of the phase ring, light coming from the specimen is guided in part to the pupil camera and in part to the phase ring,
wherein a pupil image which is uninfluenced by the phase ring is recorded and simultaneously a specimen image is output,
wherein with electronic image processing means, the position and size of an image of the modulator diaphragm, which is influenced by a specimen and uninfluenced by the phase ring, are detected in the recorded pupil image,
wherein a relative displacement between the phase ring and the modulator diaphragm is performed with electronic control means in dependence upon the detected position and the detected size of the image of the modulator diaphragm.

2. The method as defined in claim 1,
wherein
the relative displacement is performed with a phase ring, over the cross-section of which at least one of: a light intensity and/or a phase influencing of light, can be variably adjusted.

3. The method as defined in claim 1,
wherein
the specimen image is recorded with a specimen camera,
the recorded specimen image is evaluated with electronic image processing means with respect to an evaluation variable,
the relative displacement between the phase ring and the modulator diaphragm is performed also in dependence upon the evaluation of the specimen image.

4. The method as defined in claim 3,
wherein
a contrast in the specimen image is determined as the evaluation variable.

5. The method as defined in claim 3,
wherein
an edge brightening in the specimen image is determined as the evaluation variable.

6. An optical assembly for arrangement in an optical path of a light microscope, wherein the light microscope has a modulator diaphragm for restricting a light cross-section, a specimen plane, which is located in the optical path behind the modulator diaphragm and in which a specimen can be positioned, and optics for generating an intermediate image of the specimen plane,
with a phase ring, over the cross-section of which incident light can be differently influenced,
with imaging means, with which, when the optical assembly is arranged in the optical path of the light microscope, the intermediate image can be imaged via the phase ring at a specimen image output terminal,
with a pupil camera for recording a pupil image and
with a beam splitter, which is arranged in the optical path in front of the phase ring, for guiding light coming from the specimen in part to the pupil camera and in part to the phase ring,
wherein the imaging means are designed, together with the beam splitter, to generate a pupil image which is uninfluenced by the phase ring and to generate the pupil image simultaneously with the imaging of the intermediate image at the specimen image output terminal,
wherein electronic image processing means are provided, with which the position and size of an image of the modulator diaphragm, which is influenced by a specimen and uninfluenced by the phase ring, can be detected in a recorded pupil image, and wherein electronic control means are provided, with which a relative displacement between the modulator diaphragm and the phase ring can be performed in dependence upon the detected position and size of the image of the modulator diaphragm.

7. The optical assembly as defined in claim 6,
wherein
the phase ring has at least one phase-shifting matrix with liquid crystal regions which can be switched between states, in which they differently influence a phase of passing light.

8. The optical assembly as defined in claim 6,
wherein
the phase ring has polarisation-influencing means in front of the phase-shifting matrix consisting of liquid crystal regions, with which a polarisation direction of light can be adjusted to set a light absorption through the liquid crystal regions.

9. The optical assembly as defined in claim 6,
wherein
the phase ring has a further matrix with matrix elements that can be adjusted independently of each other for adjusting a light absorption.

10. The optical assembly as defined in claim 6,
wherein
the further matrix is formed with switchable liquid crystal regions.

11. The optical assembly as defined in claim 6,
wherein
the phase ring is a transmitting phase ring, with which light can pass through to generate the specimen image.

12. The optical assembly as defined in claim 6,
wherein
the phase ring is a reflecting phase ring, with which light can be reflected to generate the specimen image,
a further beam splitter is provided in the optical path in front of the phase ring, the further beam splitter forwarding light coming from an objective to the phase ring and forwarding light coming from the phase ring to the specimen image output terminal.

13. The optical assembly as defined in claim 6,
wherein
connection means are provided for connection to a camera connection of a light microscope.

14. The optical assembly as defined in claim 6,
wherein
the optical assembly is formed as an intermediate tube which has first connection means for connection to a tube connection of a light microscope and second connection means to connect at least one of: a camera or an ocular.

15. A light microscope including:
an optical assembly for arrangement in an optical path of a light microscope, wherein the light microscope has a modulator diaphragm for restricting a light cross-section, a specimen plane, which is located in the optical path behind the modulator diaphragm and in which a specimen can be positioned, and optics for generating an intermediate image of the specimen plane,
with a phase ring, over the cross-section of which incident light can be differently influenced,
with imaging means, with which, when the optical assembly is arranged in the optical path of the light microscope, the intermediate image can be imaged via the phase ring at a specimen image output terminal,
with a pupil camera for recording a pupil image and
with a beam splitter, which is arranged in the optical path in front of the phase ring, for guiding light coming from the specimen in part to the pupil camera and in part to the phase ring,
wherein the imaging means are designed, together with the beam splitter, to generate a pupil image which is uninfluenced by the phase ring and to generate the pupil image simultaneously with the imaging of the intermediate image at the specimen image output terminal,
wherein electronic image processing means are provided, with which the position and size of an image of the modulator diaphragm, which is influenced by a specimen and uninfluenced by the phase ring, can be detected in a recorded pupil image, and
wherein electronic control means are provided, with which a relative displacement between the modulator diaphragm and the phase ring can be performed in dependence upon the detected position and size of the image of the modulator diaphragm.

16. The light microscope as defined in claim 15,
wherein
the phase ring is housed within a microscope frame.
